(19) United States
(12) Patent Application Publication
(10) Pub. No.: US 2015/0025992 A1
(43) Pub. Date: Jan. 22, 2015

(54) REAL-TIME REVERSED AUCTION METHOD

(71) Applicant: TADEUSZ KASPRZAK, KRAKOW (PL)

(72) Inventor: TADEUSZ KASPRZAK, KRAKOW (PL)

(21) Appl. No.: 13/943,910

(22) Filed: Jul. 17, 2013

(51) Int. Cl. G06Q 30/08

(52) U.S. Cl. CPC G06Q 30/08
USPC 705/26.3

(57) ABSTRACT

A buyer sends an inquiry with a copy of a contract to the auction platform administrator. The administrator checks the inquiry with the contract on whether it contains sufficient and complete information. If the information is insufficient or incomplete, then the inquiry is returned to the buyer to be verified. After correcting, the revised inquiry is again sent by the buyer to the administrator. If the check of completeness of the inquiry by the administrator finds that there is sufficient information, then the product and the product cards and potential suppliers are identified. The product cards are then consolidated and sorted to obtain a ranking of the product cards. The ranking is then sent to the buyer. The ranking is also sent to the suppliers. Check if an improvement of the offer was made by a supplier. If an improvement was made by a supplier, then the product cards are again consolidated for obtaining a revised ranking and are thereupon sent to the buyer and seller.

### BACKGROUND OF THE INVENTION

1. The Field of the Invention The described invention relates to an online auction system, carried out real-time with the use of the elements of a reversed auction.

2. Brief Description of the Background of the Invention Including Prior Art

In an ordinary auction or forward auction buyers compete to obtain a good or service by offering increasingly higher prices. In a reverse auction the sellers compete to obtain business from the buyer and prices will typically decrease as the sellers undercut each other. The roles of the buyer and of the seller are reversed in a reverse auction. In a typical forward auction the seller offers an item which he wants to sell. Potential buyers are free to bid on the item until a certain time period expires. The buyer with the highest offer wins the right to purchase the item for the price determined at the end of the auction.

In a reverse auction a single buyer offers a contract out for bidding by a plurality of sellers, which are able to offer bids on the contract. As the auction progresses, the price decreases as sellers compete to offer lower bids than their competitors whilst still meeting all of the specifications of the original contract. The buyer is able to see all of the sellers' offers and can choose any of the offers submitted. Bidding performed in real-time through the Internet results in a dynamic competitive process.

### SUMMARY OF THE INVENTION

1. Purposes of the Invention

It is a purpose of the invention to furnish an improved reverse auction method.

It is another purpose of the invention to furnish a reverse auction method which is run over the internet.

It is a further purpose of the invention to consolidate the sellers in a procedural system in a timely fashion.

2. Brief Description of the Invention

A buyer forms a contract and sends an inquiry with a copy of the contract to the administrator of the auction platform. The platform administrator receives the inquiry (Request for quotation, Request for proposal) with the proposed contract. The administrator checks the inquiry with the contract on whether it contains sufficient and complete information. If the information is insufficient or incomplete, then the inquiry is returned to the buyer to be verified. After correcting, the revised inquiry is again sent by the buyer to the auction platform administrator.

If the check of completeness of the inquiry by the administrator finds that there is sufficient information, then the product and the product cards and the potential suppliers are identified. The product cards are then consolidated and sorted to obtain a ranking of the product cards. The ranking is then sent to the buyer. The ranking is also sent to the suppliers.

It is checked if an improvement of the offer was made by a supplier relative to a previous offer. If an improved offer was made by a supplier, then the product cards are again consolidated for obtaining a revised ranking and are thereupon sent to the buyer and seller. If no supplier made an offer, then it is checked whether the proceeding is terminated. If the proceeding is not terminated, then it is checked again whether an improvement of a previous offer was made by a supplier.

It is checked whether the proceeding was terminated before elapsing of a defined time period. If termination did not occur before the defined time period ended, then check whether the buyer accepted the terms of the transaction contract and if the buyer did not then cancel the proceeding. If the buyer accepted the terms of the transaction, then complete the proceeding. If termination occurred before the ending of the defined time period, then complete the proceeding. In case of completion of the proceeding or cancellation of the proceeding inform the suppliers of the outcome of the proceeding.

### BRIEF DESCRIPTION OF THE DRAWING

There is shown:

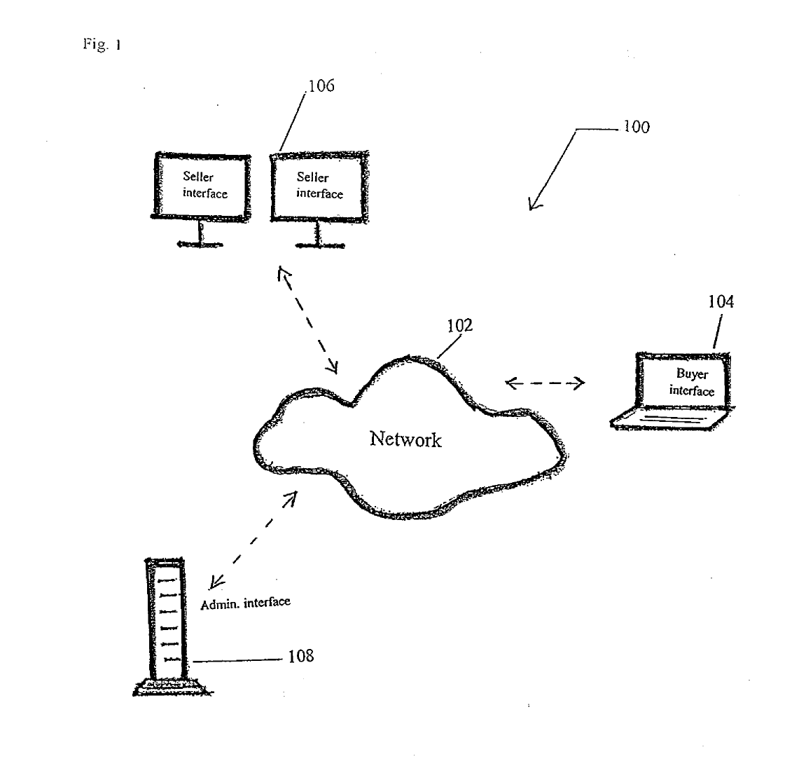

In FIG. 1 a schematic representation with a network and interface; and

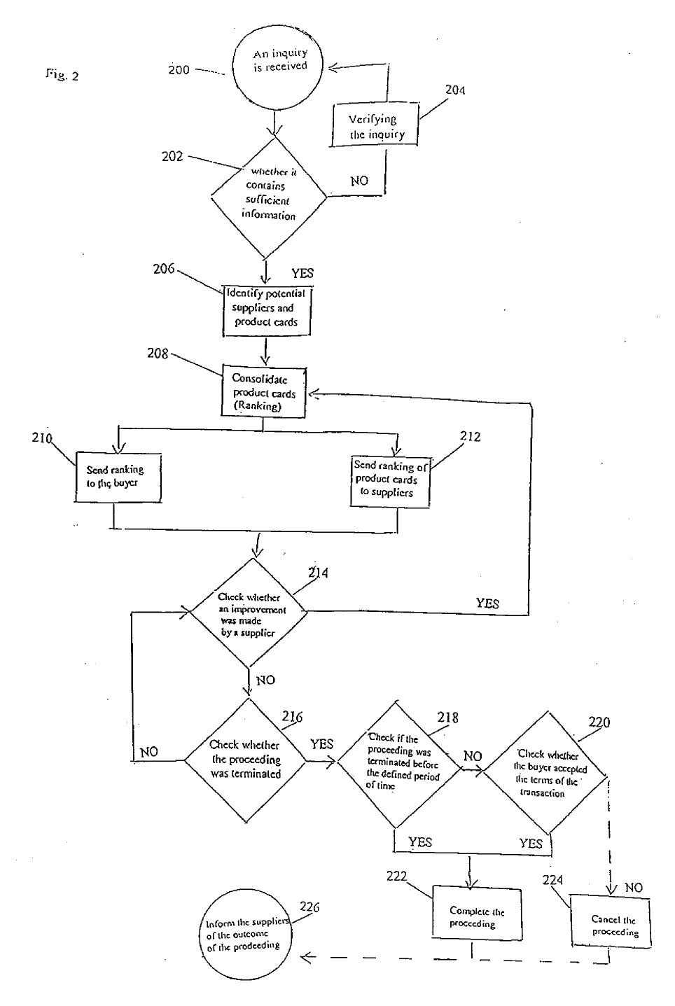

In FIG. 2 a flow diagram of the steps of the bidding method.

### DESCRIPTION OF INVENTION AND PREFERRED EMBODIMENT

FIG. 1 shows the architecture of a network within which the invention operates (100). The outlined network (102) can be any telecommunication network: it can be a local area network (LAN), a wireless network, a wide area network (WAN), a global internet network, etc. The invention may also operate within a greater number of networks of similar type connected to each other. For the purposes of communication the networks are connected to various devices that are shown separately: the buyer interface 104, the seller interface 106, and the admin interface 108.

In the described business method the term “interface” is shown in FIG. 1. and should be understood as an electric, electronic or optical system, with software or without software, that allows a connection, cooperation and/or an exchange of signals of a particular form among devices connected by the system according to a suitable technical specification, proper for a final hardware device.

A user interface is a part of the device responsible for interaction with a user, that allows introduction of data by the user, and visualization of the introduced and processed data.

There can function, within the system, many independent interfaces of buyers and suppliers, but only one of an administrator. The interface is an electric, electronic or optical system and is always inseparably linked with a user interface.

FIG. 1 shows a required minimal environment for e-commerce, in which the invention method can function. It is not possible to have less than three interfaces, always at least one buyer interface, one supplier interface, and one administrator (platform) interface must be present.

It is recommended that in the described method more interfaces of buyers be present, but this is not a necessary condition. A user interface (UI) for a subsequent/next buyer interface can be the same (subsequent copy) as a previous buyer interface.

It is recommended that in the described method more interfaces of suppliers can function, although this is not a necessary condition. The user interface (UI) for subsequent interfaces of suppliers also are the same (subsequent copy) as the interface for previous suppliers. There can be practically an infinite number of buyers and suppliers participate.

Each interface has a device for an introduction of data (input e.g. keyboard, touch screen, a telephone, a mouse), a device for processing data (processor), a device for displaying data (output, e.g. a monitor, a display, a liquid crystal display, a plasma display), and a device for storing data (a memory storage). Interfaces can also be equipped in additional devices, however, it is not a necessary condition for functioning of the discussed invention method.

Interfaces can be characterized, first of all, as providing a possibility of personalization, suitable for each user. A final user (a supplier or a buyer) may, in a limited extend, personalize his or her own interface, particularly in a way of displaying of data, sorting of ranking cards, restriction of displaying of ranking, as well as in a way of introduction of data—e.g. any system keypad, different input formats and/or auction end date.

There can be differences between various interfaces. There can be divergent access to information. There can be different forms of communication for the buyer, seller, and administrator interfaces. There can be differences in the user interface, by having a different look, or a different form of presentation of information or there can be different rules of presentation of product cards and ranking cards. Various interactive elements can be part of the interface, for example the buyer may terminate the proceedings before the requested time, the supplier can improve a prior offer.

A device is any piece of equipment which enables a two way communication between the device and the network and which saves and stores data, e.g. a desktop computer, a laptop, a tablet, a smart phone or other information display device.

FIG. 2 shows a real-time reverse auction algorithm in the e-commerce environment. The method described here can be implemented in a network environment defined in FIG. 1. As it is shown in the process step 200, the procedure begins with an inquiry (request for quotation, request for proposal) sent by the buyer via the Internet, or any other network, containing relevant information. The inquiry can concern any product or service which can, in the light of applicable law, constitute the subject matter of a trade exchange. The inquiry then is complemented by a standard reply template and contains encoded information with the details of the offer. The inquiry is received by the auction platform administrator in process step 200. For this purpose the buyer uses an interface. The encoded information can contain a detailed description of goods in demand or service, the category of the product or service, a detailed specification of the goods in demand or service, a desired location of the seller, a desired location of the buyer, a desired place of delivery of service or product, a desired time of delivery of service or product, the deadline of the negotiation process, and other specific information on the order.

Then, the procedure 202 takes place—verifying whether the sent information is sufficient for the seller. This operation is carried out via the admin interface. Verification is made automatically by an administrator (administrator interface with an appropriate software). The administrator knows all card design products and suppliers. The administrator is fully automated within the interface machine. The computer operates the relevant software that performs the operations described above, quickly and anonymously. Verification is automatic validation of fields of a query sent by the buyer to the corresponding fields in the product data cards of suppliers. At this stage there is no link between the buyer and the supplier and they have not yet identified the relevant supplier. The verifying step 202 of the veryfying the inquiry is to be performed by the administrator for situations where the inquiry of the buyer does not contain sufficient information. A separate verifying step 204 can also be made by the buyer or the administrator.

A task complement is sent automatically through the administrator interface. At this stage there is no relationship with the supplier. The buyer does not know the designs of products cards, so there is not enough information in order to verify the correctness of the query. If the seller finds that the inquiry contains sufficient information, then process step 206 is addressed for identifying potential suppliers and product cards. Identification of potential suppliers takes only place at the process step of 206.

If verifying gives a negative result, a feedback message is sent to the buyer—204, that is, pointing out missing information. If the verifying process step 202 gives a positive result, then the procedure 206 starts, i. e, a showing of potential suppliers, product cards, based on information contained in the request for quotation. Identification is based on searching for suppliers in the database as well as for such information that would match the inquiry. All suppliers, products, services etc. that are able, or potentially able to meet the needs of the buyer are being sought. Identification can be done in a variety of ways, for example in accordance with the category of product or service defined in the inquiry, using all or only part of the information contained in the inquiry. The search may be done via the admin, buyer or seller interface.

Only the administrator can perform the identification of product cards and respond to cards suppliers. Identification is done automatically, based on the inquiry. A data query is compared with the data in the database. Databases can be stored at the supplier, the buyer or the administrator. Thus a search can be carried out as part of their interfaces. The process step 208 involving consolidation and ranking of product cards is to be executed by the buyer and the step is to be performed by the administrator automatically.

After the identification, a consolidation of product cards begins (process 208). This operation is based on arranging product cards which were identified during procedure 206 in accordance with criteria. Criteria may lead to a reduction in the number of identified cards of suppliers, products or presenting them in sequence. As a result of consolidation a card ranking is created. Criteria are defined by buyer and are part of the received request for proposal at step 200.

Then, the ranking is transferred in process steps 210, 212 via a telecommunication network, the Internet or any other communication architecture described in FIG. 1 and displayed on the buyer interface as well as the interfaces of previously identified sellers or suppliers. Ranking of product cards are sent 212 to sellers and includes offers from other identified suppliers who were not rejected as a result of the consolidation 208, and they have the possibility to improve the individual offer. Ranking transferred to the buyer 210 has the possibility to end the procedure at any time. Improvement of the offer by the supplier can be based on making changes of the conditions of the transaction, such as price, delivery date, time of accomplishment, etc. The administrator sends ranking cards automatically, both to the buyer 210 as well as to the relevant suppliers 212. The ranking is displayed in the interface of the buyer and the suppliers involved in the proceedings. The interfaces are different—the user interface (User Interface) of the seller provider has the function of improving their product sheet. For example one can reduce the price, or offer additional value equivalent to make offer more competitive. The interface (User Interface) of the buyer provides the opportunity to end the auction early or immediately.

The next step is to wait for the action taken by the parties in the procedures 214 and 216. The process step 214 relates to the situation where anyone supplier submits a revised offer.

The procedure is terminated automatically by the administrator for the specified time in the buyer's inquiry. The buyer has the possibility to end earlier. Checking whether the provider seller has submitted improved offers is done automatically by the administrator.

If anyone of the suppliers sends a revised offer via his or her interface, re-consolidation of the ranking is being done and the procedure 214 of checking whether an improved offer was made, becomes redirected to consolidation procedure 208 and transferring the re-consolidated ranking to the buyer and the seller as the parties involved 210, 212. As a result of re-consolidation, the position of product cards of suppliers participating in the proceeding can be changed. Suppliers can improve their offer many times until the end of the proceeding with procedure 216. The interface pages of the buyer, of the seller and of the administrator are generally different.

The end of the proceeding can take place after the selection of a particular offer by the buyer or after the end of a period of time if the end time was previously defined. Checking for an end of the procedure is done by the administrator. If the buyer makes use of interactive features in its interface like “exit procedure” then information is sent to the administrator about the call to that function in the user interface and the administrator automatically terminates the proceedings.

The next step is to check whether the proceeding was terminated before the period of time defined in the inquiry under procedure 218. If yes, it is assumed that the buyer has made a decision and the proceeding is terminated in process step 222. If not, one shall obtain a confirmation of the acceptance of terms of the transaction by the buyer (procedure 220). The checking of the procedure 220 is performed automatically by the administrator. The acceptance of the terms of the transaction by the buyer is done to prevent an unexpected and unwanted result of the auction. If the buyer does not confirm the conditions of the transaction within a defined period of time, the proceeding is canceled (procedure 224). The procedure 224 is canceled by the administrator by sending relevant information to the interfaces of the participants.

If the buyer confirms the terms of the transaction, then the proceeding is completed in procedural step 222.

Termination of proceedings takes place automatically and therefore the administrator is needed, after a defined time by the buyer, or after calling up an interactive function “complete investigation” by the buyer in process step 218. The supplier cannot terminate the proceedings.

At this stage payment may be requested for the transaction in case of certain goods or services are to be delivered. Regardless of the outcome of the proceedings (procedure 222 or 224), operation 226 takes place as a result of which the suppliers participating in the proceeding are informed of the outcome of the proceeding. Interfaces of the buyer, the seller, and the administrator are involved in the termination of the procedure. Termination of proceedings takes place by sending 226 relevant information to the buyer and supplier interfaces.

The supplier whose offer has been selected is notified about the selection of his offer by a separate message with more information on the subject. The method described above provides an efficient and anonymous way of implementation of orders. This method can also be used to fulfill orders not related to trade exchange—for example, donation of old furniture.

1. A method of real-time reverse auctioning comprising
sending an inquiry by a buyer from a first network interface;
receiving the inquiry by a supplier at a second network interface;
checking completeness of the inquiry received by the supplier at the second network interface; if checking by the supplier gives an answer “incomplete” then a message is sent to the buyer and the buyer verifies or revises the inquiry and sends the inquiry out again;
if checking by the supplier gives an answer “complete”, then potential suppliers and product cards are identified;
consolidating product cards and establishing a ranking of the product cards;
sorting the potential suppliers according to certain criteria and ranking;
sending sorted potential suppliers to the buyer;
sending ranking of products to the suppliers;
checking if the supplier made an improvement of a previous offer made by the supplier;
determinating if an improvement was made by supplier, sort the potential suppliers together with an improved offer;
determinating if no improvement was made by a supplier check whether the proceeding was terminated;
if the proceeding was not terminated, check whether an improvement was made by a supplier;
if the proceeding was terminated, check if the proceeding was terminated before a defined period of time;
if the proceeding was terminated before ending of the defined period of time, complete the proceeding;
if the proceeding was not terminated before the ending of the defined period of time, check whether the buyer accepted the terms of the transaction;
if the buyer accepted the terms of the transaction, complete the proceeding;
if the buyer did not accept the terms of the transaction, cancel the proceeding;
if the proceeding was completed or canceled, inform the suppliers of the outcome of the proceeding.

2. The method of real-time reverse auction according to claim 1 further comprising complementing the inquiry with a standard reply template.

3. The method of real-time reverse auction according to claim 1 wherein the inquiry contains encoded information with details of an order.

4. The method of real-time reverse auction according to claim 1 further comprising notifying the supplier, whose offer was selected, by a separate message with more information about a subject.
